(19) United States
(12) Patent Application Publication
(10) Pub. No.: US 2023/0220564 A1
(43) Pub. Date: Jul. 13, 2023

(54) SODIUM HYPOCHLORITE PRODUCING SYSTEM

(71) Applicant: TECHWIN CO., LTD., Cheongju-si (KR)

(72) Inventors: Boong Ik JUNG, Cheongju-si (KR); Jung Sik KIM, Sejong-si (KR); Tae Shin CHO, Cheongju-si (KR); Dong Hyuck CHOI, Cheongju-si (KR); Tae Woo KIM, Cheongju-si (KR)

(73) Assignee: TECHWIN CO., LTD., Cheongju-si (KR)

(21) Appl. No.: 18/185,062

(22) Filed: Mar. 16, 2023

Related U.S. Application Data
(63) Continuation of application No. PCT/KR2021/013974, filed on Oct. 12, 2021.

(30) Foreign Application Priority Data
Oct. 13, 2020 (KR) 10-2020-0131651

(51) Int. Cl. C25B 1/46; C25B 9/19; C25B 15/021; C25B 15/027; C25B 15/033; C25B 15/08

(52) U.S. Cl. CPC C25B 1/46; C25B 9/19; C25B 15/021; C25B 15/027; C25B 15/033; C25B 15/083

(57) ABSTRACT

One aspect of the present invention provides a sodium hypochlorite producing system, which includes: a first means configured to obtain saturated salt water and purified water; a second means including a anode chamber and a cathode chamber which are partitioned by a separator, the anode chamber allowing the saturated salt water to be converted into a anodic product including chlorine gas and anodic water, and the cathode chamber allowing the purified water to be converted into a cathodic product including sodium hydroxide, hydrogen gas, and hydroxide ions (OH⁻); a third means configured to react the anodic product and the cathodic product to produce a mixture including sodium hypochlorite and hydrogen gas; and a fourth means configured to prevent the sodium hydroxide or hydroxide ions (OH⁻) of the cathodic product or a combination thereof from moving to the anode chamber through the separator.

### CROSS-REFERENCE TO RELATED APPLICATIONS

This application is a continuation of International Patent Application No. PCT/KR2021/013974, filed on Oct. 12, 2021, which claims priority to and the benefit of Korean Patent Application No. 10-2020-0131651, filed on Oct. 13, 2020, the disclosure of which is incorporated herein by reference in its entirety.

### TECHNICAL FIELD

The present invention relates to a sodium hypochlorite producing system.

### BACKGROUND ART

Sodium hypochlorite (NaOCl) is being applied in various fields such as water supply and sewage, wastewater treatment, seawater electrolysis, ballast water treatment, agricultural food and food material sterilization, and the like.

Sodium hypochlorite is produced using a low-concentration sodium hypochlorite producing system and a high-concentration sodium hypochlorite producing system according to a concentration thereof.

Low-concentration sodium hypochlorite having a concentration of 0.4 to 1.0% is obtained by passing salt water through a separator-free electrolysis bath in which a contact-type electrode reaction takes place. High-concentration sodium hypochlorite having a concentration of 2% or more is obtained by reacting chlorine gas produced in a separator-containing electrolysis bath, in which a anode and a cathode are partitioned by a separator, with sodium hydroxide in a separate reaction unit.

FIG. 1 is a schematic diagram of a conventional system of producing high-concentration sodium hypochlorite. Referring to FIG. 1, a conventional sodium hypochlorite producing system may include: a raw water treatment unit 10 configured to treat raw water to obtain purified water; and a salt water treatment unit 22 configured to treat saturated salt water prepared from some of purified water and salt stored in a salt tank 21, and the purified saturated salt water and residual purified water obtained in the salt water treatment unit 22 may be transferred to a anode chamber and a cathode chamber constituting an electrolysis unit 40, respectively.

The electrolysis unit 40 is a separator-containing electrolysis bath and may include a anode chamber, a cathode chamber, and a separator that partitions the anode chamber and the cathode chamber. The anode chamber and the cathode chamber may include a anode bath 50 and a cathode bath 60 that allow a anodic product and a cathodic product to be circulated, respectively.

Anodic water and chlorine gas may be separated in the anode bath 50, cathodic water and hydrogen gas may be separated in the cathode bath 60, and the chlorine gas and cathodic water may be transferred to a separate reaction unit 70 and allowed to react to obtain sodium hypochlorite.

Since the anodic water contains chlorine compounds such as OCl⁻, HOCl, and ClO₃⁻ as well as sodium chloride (NaCl) which is a raw reaction material in the anode chamber, the anodic water may be desalinated with hydrochloric acid, sodium hydroxide, or the like and then discharged to the outside or circulated to the salt tank 21 for reuse. Particularly, since the ClO₃⁻ component is not removed by conventional desalination treatment and accumulated, the anodic water needs to be discharged to the outside according to a predetermined condition, and in this case, the surrounding environment is contaminated due to discharged anodic water.

In addition, as various types of equipment (tanks, pipes, and the like) for physical and chemical treatment such as gas-liquid separation and desalination of the anodic product and the cathodic product are complicatedly configured, a maintenance burden increases.

Accordingly, there has been proposed a method of injecting the anodic water into produced sodium hypochlorite without reuse and/or discharge. In order to maintain the concentration and/or pH of produced sodium hypochlorite within predetermined ranges, the concentration of sodium hydroxide (NaOH) in cathodic water needs to increase. In this case, sodium hydroxide, hydroxide ions (OH⁻), and the like are introduced into a anode chamber through a separator, and thus the pH of anodic water increases. Referring to FIG. 4, when the pH of an aqueous solution in which chlorine gas (Cl₂) is dissolved increases, the concentration of chlorine gas in the aqueous solution decreases, whereas concentrations of HOCl and OCl⁻ components relatively increase. The HOCl and OCl⁻ components, whose concentrations are increased in anodic water, react with each other to produce ClO₃⁻, and thus the concentration of a ClO₃⁻ component in anodic water increases.

In addition, when anodic water in which the concentration of a ClO₃⁻ component increases is injected into produced sodium hypochlorite, the concentration of a ClO₃⁻ component in sodium hypochlorite increases, and an excessive amount of a ClO₃⁻ component also remains in a target treated with the sodium hypochlorite, thereby adversely affecting the surrounding environment or the human body (ClO₃⁻ is a material harmful to the human body, which is included in drinking water quality monitoring items).

### DISCLOSURE

### Technical Problem

The present invention is designed to solve the above-described problems of the related art and directed to providing a sodium hypochlorite producing system which is environmentally friendly and has easy maintenance.

### Technical Solution

One aspect of the present invention provides a sodium hypochlorite producing system, which includes: a first means configured to obtain saturated salt water and purified water; a second means including a anode chamber and a cathode chamber which are partitioned by a separator, the anode chamber allowing the saturated salt water to be converted into a anodic product including chlorine gas and anodic water, and the cathode chamber allowing the purified water to be converted into a cathodic product including sodium hydroxide, hydrogen gas, and hydroxide ions (OH⁻); a third means configured to react the anodic product and the cathodic product to produce a mixture including sodium hypochlorite and hydrogen gas; and a fourth means configured to prevent the sodium hydroxide or hydroxide ions (OH⁻) of the cathodic product or a combination thereof from moving to the anode chamber through the separator.

In an embodiment, the third means may allow the anodic product and the cathodic product to react in-situ.

In an embodiment, the separator may have permeability to cations.

In an embodiment, a surface of the separator facing the cathode chamber may have a blocking property against anions.

In an embodiment, a surface of the separator facing the cathode chamber may have a cation-exchange functional group.

In an embodiment, the cation-exchange functional group may be a carboxyl group, a sulfonic acid group, or a combination thereof.

In an embodiment, the fourth means may include: a temperature sensor configured to measure a temperature of the anodic product, the cathodic product, or a combination thereof; and a heat exchanging means configured to control a temperature of the anode chamber, the cathode chamber, or a combination thereof according to a signal of the temperature sensor.

In an embodiment, the fourth means may include a conductivity sensor configured to measure a conductivity of the anodic product, the cathodic product, or a combination thereof; and a flow rate control means configured to control an amount of the saturated salt water, the purified water, or a combination thereof, which are injected into the second means, according to a signal of the conductivity sensor.

In an embodiment, the fourth means may include: an ORP sensor configured to measure an oxidation-reduction potential of the anodic product, the cathodic product, or a combination thereof; and a flow rate control means configured to control an amount of the saturated salt water, the purified water, or a combination thereof, which are injected into the second means, according to a signal of the ORP sensor.

In an embodiment, the third means may further include a gas-liquid separating means configured to separate and discharge hydrogen gas from the mixture.

### Advantageous Effects

Since a sodium hypochlorite producing system according to one aspect of the present invention includes a means for preventing sodium hydroxide, hydroxide ions (OH⁻), and the like of a cathodic product produced in a cathode chamber of a separator-containing electrolysis unit from moving to a anode chamber through a separator, an increase in concentration of a ClO₃⁻ component in anodic water beyond the standard is effectively prevented, and thus the safety of sodium hypochlorite used as a disinfectant, a treatment agent, and the like can be improved.

In addition, since the entire amount of the anodic product and the cathodic product is substantially and effectively reacted in the third means of the sodium hypochlorite producing system, environmental problems resulting from production and discharge of anodic water including a plurality of chlorine compounds as impurities can be solved.

Additionally, since the second means for electrolysis in the sodium hypochlorite producing system includes a anode chamber, a cathode chamber, and a separator and, as necessary, does not include a cathode bath for circulating a cathodic product obtained in the cathode chamber and/or a anode bath for circulating a anodic product obtained in the anode chamber, a conventional problem in which the surrounding environment is deteriorated as anodic water containing a large amount of by-products is discharged from a anodic water tank can be solved.

However, it is to be understood that the effects of the present invention are not limited to the above-described effects and include all effects deducible from the configuration of the invention described in the detailed description of the present invention or in the claims.

### DESCRIPTION OF DRAWINGS

FIG. 1 is a schematic diagram of a conventional sodium hypochlorite production device.

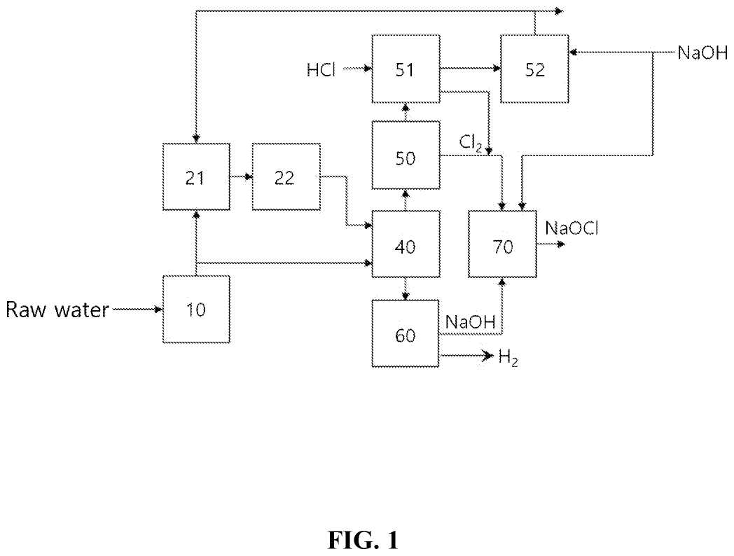

FIG. 2 is a schematic diagram of a sodium hypochlorite producing system according to an embodiment of the present invention.

FIG. 3 is a schematic diagram of an electrolysis unit according to an embodiment of the present invention.

FIG. 4 is a graph showing a relative concentration of chlorine compounds according to pH.

### MODES OF THE INVENTION

Hereinafter, the present invention will be described in detail with reference to accompanying drawings. However, it should be understood that the present invention can be implemented in various forms, and that it is not intended to limit the present invention to the exemplary embodiments. Also, in the drawings, descriptions of parts unrelated to the detailed description are omitted to clearly describe the present invention. Throughout the specification, like numbers refer to like elements.

Throughout the specification, a certain part being “connected” to another part means that the certain part is “directly connected” to the other part or that the certain part is “indirectly connected” to the other part through another member interposed between the two parts. Also, a certain part “including” a certain element signifies that the certain part may further include, instead of excluding, another element unless particularly indicated otherwise.

Hereinafter, exemplary embodiments of the present invention will be described in detail with reference to the accompanying drawings.

Sodium Hypochlorite Producing System

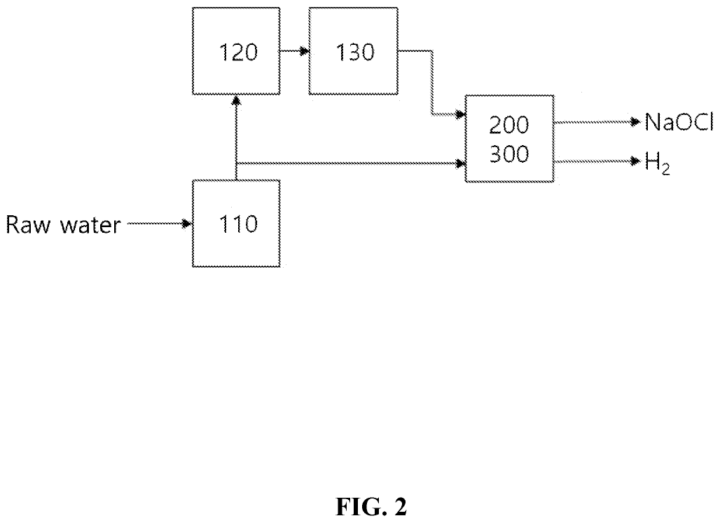

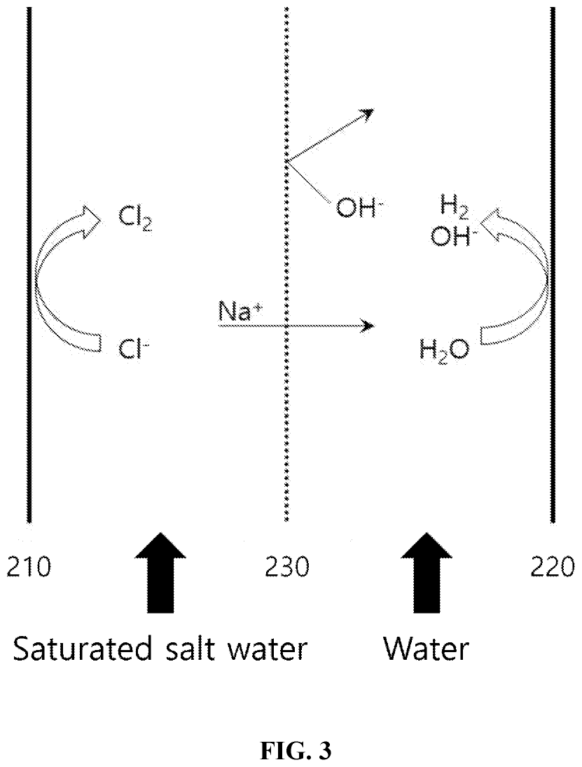

FIG. 2 is a schematic diagram of a sodium hypochlorite producing system according to an embodiment of the present invention, and FIG. 3 is a schematic diagram of an electrolysis unit according to an embodiment of the present invention.

Referring to FIGS. 2 and 3, a sodium hypochlorite producing system according to one aspect of the present invention includes: a first means 110, 120, 130 configured to obtain saturated salt water and purified water; a second means 200 including a anode chamber and a cathode chamber which are partitioned by a separator, the anode chamber allowing the saturated salt water to be converted into a anodic product including chlorine gas and anodic water, and the cathode chamber allowing the purified water to be converted into a cathodic product including sodium hydroxide, hydrogen gas, and hydroxide ions (OH⁻); a third means 300 configured to react the anodic product and the cathodic product to produce a mixture including sodium hypochlorite and hydrogen gas; and a fourth means configured to prevent the sodium hydroxide or hydroxide ions (OH⁻) of the cathodic product or a combination thereof from moving to the anode chamber through the separator.

The first means may include a raw water treatment unit 110, a salt tank 120, and a salt water treatment unit 130.

The raw water treatment unit 110 may produce purified water by removing impurities such as calcium, magnesium, and the like from raw water. The raw water treatment unit may use one selected from the group consisting of a water softener, a reverse osmosis membrane process, a nano-membrane process, an electrodialysis process, an electrosorption deionization process, and a combination of two or more thereof and preferably uses a water softener and/or a reverse osmosis membrane process, but the present invention is not limited thereto.

Some of purified water produced in the raw water treatment unit 110 may be supplied to the salt tank 120 to produce saturated salt water, and the residual purified water may be supplied to a cathode chamber 220 of the second means 200 and converted into a cathodic product including sodium hydroxide, hydrogen gas, and hydroxide ions (OH⁻).

The salt tank 120 may store solid-phase salt. The salt may be dissolved in purified water provided by the raw water treatment unit 110 and supplied in an aqueous solution to a anode chamber 210 of the second means 200.

The salt tank 120 may store salt supplied from the outside. The salt tank may be supplied with purified water from the raw water treatment unit 110 to produce an aqueous solution in which the salt is dissolved, preferably, saturated salt water, and may supply the aqueous solution to the anode chamber 210 of the second means 200.

The salt tank 120 may include: a salt supply portion through which the salt is introduced in a solid state from the outside; a purified water inlet through which purified water is supplied from the raw water treatment unit 110; and a saturated salt water outlet through which the saturated salt water is discharged.

In addition, the salt water treatment unit 130 may be provided between the salt tank 120 and the anode chamber 210. Since the salt water treatment unit 130 prevents contamination of a separator 230 of the second means 200 by removing impurities such as calcium, magnesium, and the like included in saturated salt water discharged from the salt tank 120, the salt water treatment unit may serve to increase electrolysis efficiency and the lifespan of the separator 230.

The salt water treatment unit 130 may include: a heating portion provided with a heater in a water bath having a predetermined size; and a water softening unit provided with a chelating resin capable of adsorbing and removing impurities in salt water passing through the heating portion. The heating portion may improve the adsorption efficiency of the water softening unit by appropriately maintaining the temperature and pH of unpurified saturated salt water. For example, the appropriate temperature and pH of saturated salt water may be 50 to 80° C. and 9 or more, respectively, but the present invention is not limited thereto.

The second means 200 may be a separator-containing electrolysis unit including the anode chamber 210 and the cathode chamber 220 which are partitioned by the separator 230, wherein the anode chamber 210 may allow the saturated salt water to be converted into a anodic product including chlorine gas and anodic water, and the cathode chamber 220 may allow the purified water to be converted into a cathodic product including sodium hydroxide, hydrogen gas, and hydroxide ions (OH⁻).

The anode chamber 210 may include a anode and may be loaded with anodic water including a material produced by an electrolysis reaction at the anode and a gas-phase material. Also, the cathode chamber 220 may include a cathode and may be loaded with cathodic water including a material produced by an electrolysis reaction at the cathode and a gas-phase material.

When a predetermined voltage is applied to the second means 200, the following materials may be produced in the anode chamber 210 and the cathode chamber 220.

A anodic product including sodium ions (Na⁺), chlorine gas (Cl₂), and chlorine ions (Cl⁻) may be produced in the anode chamber 210, and a cathodic product including hydrogen gas (H₂) and hydroxide ions (OH⁻) may be produced in the cathode chamber 220. The sodium ions produced in the anode chamber 210 may move to the cathode chamber 220 through the separator 230 and react with the hydroxide ions produced in advance in the cathode chamber 220 to produce sodium hydroxide.

The third means 300 may allow the anodic product and the cathodic product to react to produce a mixture including sodium hypochlorite, anodic water, and hydrogen gas.

In the third means 300, a mixture including sodium hypochlorite, which is produced by a reaction between chlorine gas of the anodic product and sodium hydroxide of the cathodic product, and hydrogen gas transferred to the third means along with sodium hydroxide of the cathodic product may be produced.

Particularly, since the entire amount of the anodic product and the cathodic product is substantially and effectively reacted in the third means 300, environmental problems resulting from the production and discharge of anodic water including chlorine compounds such as OCl⁻, HOCl, and ClO₃⁻ as impurities can be solved.

The third means 300 may be separately provided outside the second means 200. A anode bath and a cathode bath may be provided between the anode chamber 210 and the third means 300 and between the cathode chamber 220 and the third means 300, respectively, and anodic water and cathodic water stored in the anode bath and the cathode bath may be circulated between the anode chamber and the anode bath and between the cathode chamber and the cathode bath, respectively. The anode bath and the cathode bath are equipment for storing anodic water and cathodic water that circulate through the anode chamber 210 and cathode chamber 220 of the second means 200, respectively.

However, in this case, to appropriately circulate and discharge materials produced in the anode chamber 210 and the cathode chamber 220, equipment such as a storage bath, a pipe, and the like becomes complicated, and a ClO₃⁻ concentration is increased as anodic water is left in a high-temperature anode bath for a long period of time.

Accordingly, by forming the third means 300 and the second means 200 as one integrated unit, a anode bath, a cathode bath, a circulating pipe, and the like may be appropriately omitted, and maintenance, environmental friendliness, and the like may be significantly improved.

When the second and third means 200 and 300 are formed as one integrated unit, chlorine gas and sodium hydroxide respectively produced in the anode chamber 210 and cathode chamber 220 of the second means 200 may be transferred to the third means 300 provided downstream of the second means 200 and then reacted in-situ to produce sodium hypochlorite.

As used herein, the term “in-situ reaction” refers to a series of processes in which chlorine gas, anodic water, and sodium hydroxide are produced in the anode chamber 210 and the cathode chamber 220 and simultaneously and effectively reacted to produce sodium hypochlorite in real time.

The residual sodium hydroxide, which is not involved in production of sodium hypochlorite, of sodium hydroxide produced in the cathode chamber 220, may serve as a buffer that adjusts the pH of produced sodium hypochlorite within a predetermined range. In this case, the sodium hypochlorite producing system may not include equipment for injecting sodium hydroxide into the third means from the outside.

The in-situ reaction between the anodic product and the cathodic product, which takes place in the third means 300, may be implemented by the fourth means (not shown) that controls a material balance in the anode chamber 210 and cathode chamber 220 of the second means 200, specifically, a concentration gradient of hydroxide ions (OH⁻) between the anode chamber 210 and the cathode chamber 220.

As described above, to solve problems resulting from circulation and discharge of anodic water, there has been proposed a method of injecting anodic water into produced sodium hypochlorite without reuse and/or discharge.

In order to maintain the concentration and/or pH of produced sodium hypochlorite within predetermined ranges, the concentration of sodium hydroxide (NaOH) in cathodic water needs to be increased, for example, by injecting sodium hydroxide into the cathode chamber 220 from the outside. In this case, sodium hydroxide, hydroxide ions (OH⁻), and the like are introduced into the anode chamber 210 through the separator 230, and thus the pH of anodic water is increased.

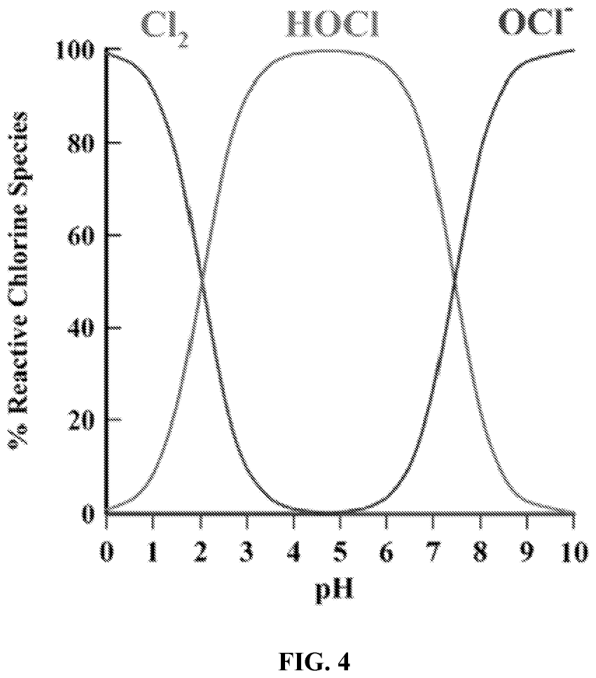

Referring to FIG. 4, when the pH of anodic water in which chlorine gas (Cl₂) is dissolved increases, the concentration of chlorine gas in the anodic water decreases, whereas concentrations of HOCl and OCl⁻ components relatively increase. The HOCl and OCl⁻ components, whose concentrations are increased in anodic water, react with each other to produce ClO₃⁻, and thus the concentration of a ClO₃⁻ component in anodic water increases.

In addition, when anodic water in which the concentration of a ClO₃⁻ component increases is injected into produced sodium hypochlorite, the concentration of a ClO₃⁻ component in sodium hypochlorite increases, and an excessive amount of a ClO₃⁻ component also remains in a target treated with the sodium hypochlorite, thereby adversely affecting the surrounding environment or the human body.

Accordingly, the fourth means may prevent the sodium hydroxide or hydroxide ions (OH⁻) of the cathodic product or a combination thereof from moving to the anode chamber 210 through the separator 230. In other words, the fourth means may serve to maintain a high concentration of sodium hydroxide in the cathodic product and simultaneously maintain a low concentration of ClO₃⁻ component in the anodic product.

The separator 230 may be an ion-exchange membrane, preferably a cation-exchange membrane having permeability to cations. The cation-exchange membrane may allow sodium ions (Na⁺) produced in the anode chamber 210 to permeate and move to the cathode chamber 220.

In addition, a surface of the separator 230 facing the cathode chamber 220 may have a blocking property against anions. For example, a surface of the separator 230 facing the cathode chamber 220 may include an additional layer and/or functional group capable of preventing sodium hydroxide (NaOH) and hydroxide ions (OH⁻) produced in the cathode chamber 220 from permeating and moving to the anode chamber 210.

A surface of the separator facing the cathode chamber may have a cation-exchange functional group. For example, the cation-exchange functional group may be a carboxyl group, a sulfonic acid group, or a combination thereof and is preferably a carboxyl group, but the present invention is not limited thereto.

The separator may contribute to maintaining the concentration of a ClO₃⁻ component in anodic water below a predetermined range by preventing the sodium hydroxide or hydroxide ions (OH⁻) of the cathodic product or a combination thereof from moving to the anode chamber 210 through the separator 230.

The fourth means may include: a temperature sensor configured to measure the temperature of the anodic product, the cathodic product, or a combination thereof; and a heat exchanging means configured to control the temperature of the anode chamber 210, the cathode chamber 220, or a combination thereof according to a signal of the temperature sensor.

As the temperature of the second means 200 is higher, the movement of ions through the separator 230, particularly, the movement of hydroxide ions (OH⁻) from the cathode chamber 220 to the anode chamber 210 is promoted. Therefore, when the temperature of the anode chamber, the cathode chamber, or a combination thereof is adjusted to a level that does not excessively increase a voltage applied to the second means 200, the movement of the sodium hydroxide or hydroxide ions (OH⁻) of the cathodic product or a combination thereof to the anode chamber 210 through the separator 230 may be effectively prevented.

Specifically, when a temperature sensor configured to measure the temperature of the anodic product, the cathodic product, or a combination thereof is installed on the outlet side of the second means 200, and the temperature of an electrolysis product, which is measured by the temperature sensor, exceeds a predetermined range, the temperature sensor may provide a signal for cooling to the heat exchanging means provided in the anode chamber 210, the cathode chamber 220, or a combination thereof to control the temperature of the second means 200.

The fourth means may include: a conductivity sensor and/or an ORP sensor which are configured to measure the conductivity and/or oxidation-reduction potential of the anodic product, the cathodic product, or a combination thereof; and a flow rate control means configured to control the amount of saturated salt water, purified water, or a combination thereof, which are injected into the second means 200, according to a signal of the conductivity sensor and/or the ORP sensor.

As the concentration of sodium hydroxide in the cathodic product is higher, the conductivity and oxidation-reduction potential of the cathodic product are increased, and a concentration gradient of sodium hydroxide between the anode chamber 210 and the cathode chamber 220 is increased. Such a concentration gradient may promote the movement of hydroxide ions (OH⁻) from the cathode chamber 220 to the anode chamber 210.

Accordingly, when a conductivity sensor and/or an ORP sensor which are configured to measure the conductivity and/or oxidation-reduction potential of the cathodic product are/is installed on the outlet side of the cathode chamber 220, and the conductivity and/or oxidation-reduction potential of the cathodic product, which are/is measured by the conductivity sensor and/or the ORP sensor, exceed predetermined ranges, the conductivity sensor and/or the ORP sensor may provide a signal for increasing the flow rate of purified water to the flow rate control means configured to control the flow rate of purified water injected into the cathode chamber 220 to appropriately dilute the concentration of sodium hydroxide in the cathodic product.

As the concentration of sodium hydroxide in the cathodic product is diluted, the concentration gradient of sodium hydroxide between the anode chamber 210 and the cathode chamber 220 is decreased, and thus the movement of the sodium hydroxide or hydroxide ions (OH⁻) of the cathodic product or a combination thereof to the anode chamber 210 through the separator 230 may be effectively prevented.

The third means 300 may further include a gas-liquid separating means configured to separate and discharge hydrogen gas from the mixture. Since the hydrogen gas produced in the cathode chamber 220 is not involved in production of sodium hypochlorite at all, the hydrogen gas is one of the representative by-products that need to be separated and discharged.

In the case of a conventional sodium hypochlorite producing system, the hydrogen gas is separated and discharged from a cathode bath provided so that a material produced in a cathode chamber is circulated. However, since the sodium hypochlorite producing system according to the present invention does not include a cathode bath, sodium hypochlorite produced in the third means 300 may be present in a mixed state with a certain amount of hydrogen gas.

The gas-liquid separating means may stably maintain the concentration of produced sodium hypochlorite by selectively separating and discharging hydrogen gas from the mixture produced in the third means 300 and may contribute to the overall safety of the sodium hypochlorite producing system by reducing the risk of hydrogen exploding.

The foregoing description of the present invention is intended for illustration, and it will be understood by those skilled in the art to which the present invention pertains that the present invention can be easily modified and implemented in various other forms without changing the technical spirit or essential features of the present invention. Therefore, it should be understood that the embodiments described above are only exemplary in all aspects and not limiting. For example, each of the constituents described as being one combined entity may be implemented separately, and similarly, constituents described as being separate entities may be implemented in a combined form.

It should be understood that the scope of the present invention is defined by the following claims and that all changes or modifications derived from the meaning and scope of the claims and their equivalents are included in the scope of the present invention.

### LIST OF REFERENCE NUMERALS

10, 110: raw water treatment unit

21, 120: salt tank

22, 130: salt water treatment unit

40, 200: electrolysis unit

50: anode bath

51: primary desalination unit

52: secondary desalination unit

60: cathode bath

70, 300: reaction unit

210: anode (anode chamber)

220: cathode (cathode chamber)

230: separator

1. A sodium hypochlorite producing system comprising:
a first means configured to obtain saturated salt water and purified water;
a second means including a anode chamber and a cathode chamber which are partitioned by a separator, the anode chamber allowing the saturated salt water to be converted into a anodic product including chlorine gas and anodic water, and the cathode chamber allowing the purified water to be converted into a cathodic product including sodium hydroxide, hydrogen gas, and hydroxide ions (OH⁻);
a third means configured to react the anodic product and the cathodic product to produce a mixture including sodium hypochlorite and hydrogen gas; and
a fourth means configured to prevent the sodium hydroxide or hydroxide ions (OH⁻) of the cathodic product, or a combination thereof from moving to the anode chamber through the separator.

2. The sodium hypochlorite producing system of claim 1, wherein the third means allows the anodic product and the cathodic product to react in-situ.

3. The sodium hypochlorite producing system of claim 1, wherein the separator has permeability to cations.

4. The sodium hypochlorite producing system of claim 3, wherein a surface of the separator facing the cathode chamber has a blocking property against anions.

5. The sodium hypochlorite producing system of claim 4, wherein a surface of the separator facing the cathode chamber has a cation-exchange functional group.

6. The sodium hypochlorite producing system of claim 5, wherein the cation-exchange functional group is a carboxyl group, a sulfonic acid group, or a combination thereof.

7. The sodium hypochlorite producing system of claim 1, wherein the fourth means includes:
a temperature sensor configured to measure a temperature of the anodic product, the cathodic product, or a combination thereof; and
a heat exchanging means configured to control a temperature of the anode chamber, the cathode chamber, or a combination thereof according to a signal of the temperature sensor.

8. The sodium hypochlorite producing system of claim 1, wherein the fourth means includes:
a conductivity sensor configured to measure a conductivity of the anodic product, the cathodic product, or a combination thereof; and
a flow rate control means configured to control an amount of the saturated salt water, the purified water, or a combination thereof, which are injected into the second means, according to a signal of the conductivity sensor.

9. The sodium hypochlorite producing system of claim 1, wherein the fourth means includes:
an ORP sensor configured to measure an oxidation-reduction potential of the anodic product, the cathodic product, or a combination thereof; and
a flow rate control means configured to control an amount of the saturated salt water, the purified water, or a combination thereof, which are injected into the second means, according to a signal of the ORP sensor.

10. The sodium hypochlorite producing system of claim 1, wherein the third means further includes a gas-liquid separating means configured to separate and discharge hydrogen gas from the mixture.
